(19) United States
(12) Patent Application Publication
(10) Pub. No.: US 2015/0233085 A1
(43) Pub. Date: Aug. 20, 2015

(54) IMPLEMENT SYSTEM

(71) Applicant: Caterpillar Inc., Peoria, IL (US)

(72) Inventor: Gregory A. Seljestad, Wamego, KS (US)

(73) Assignee: Caterpillar Inc., Peoria, IL (US)

(21) Appl. No.: 14/184,066

(22) Filed: Feb. 19, 2014

(51) Int. Cl. E02F 3/36; B66F 9/12; E02F 3/40

(52) U.S. Cl. CPC E02F 3/3609; E02F 3/3663; E02F 3/40; B66F 9/12

(57) ABSTRACT

The present disclosure provides a coupler for attaching an implement to a machine. The coupler includes a mounting structure. The mounting structure includes a frame and an attachment part rigidly attached to the frame. The attachment part is configured to attach the coupler with the machine. The mounting structure includes a mounting hole disposed on the frame. The mounting hole is configured to receive a mounting pin disposed on the implement. The coupler further includes a locking mechanism. The locking mechanism includes an actuation system rigidly coupled to the mounting structure. The locking mechanism includes a catch plate operatively connected to the actuation system and configured to selectively lock the mounting pin received in the mounting hole.

### TECHNICAL FIELD

The present disclosure relates to an implement system for a machine and more particularly to a coupler and a locking mechanism to securely couple an implement with the coupler.

### BACKGROUND

Typically machines associated with mining, agriculture, forestry, construction, and other industrial applications include an implement system having a coupler that allows various implements to be coupled and uncoupled to the machine. Theses couplers may have a support frame and a locking mechanism to allow a quick connection with the implement. An operator may couple and/or uncouple the implement using one or more controls disposed in the operator cabin. However, during coupling of the implement an alignment of the support frame with the implement may not be proper and that an operator may not have a view of both the components. Further, this misalignment and/or partial coupling may lead to an early wear in the components and may require frequent servicing and/or replacement of the implement and/or the coupler. Thus, operator has to get down from the operator cabin and check for the alignment and/or the coupling of the implement to the coupler. Sometimes, the operator may move or shake the implement system to be certain that the implement is mounted properly.

U.S. Pat. No. 4,480,955 discloses a quick release and attachment coupling for operating tools for earthmoving or excavating machines having an attachment head pivotally mounted on the boom of the machine. A locating head is fixed to, or formed integrally with, an operating tool and has a pair of spaced side plates, and stop members in the form of a transverse bar or beam and a hook or jaw. The attachment head is tightly positioned between the spaced side plates, with V-shaped slots at one end of the head engaged with the beam. A movable block in the head is moved by a hydraulic ram into engagement with the hook or jaw to lock the attachment head to the operating tool.

### SUMMARY

In one aspect, the present disclosure provides a coupler for attaching an implement to a machine. The coupler includes a mounting structure. The mounting structure includes a frame and an attachment part rigidly attached to the frame. The attachment part is configured to attach the coupler with the machine. The mounting structure includes a mounting hole disposed on the frame. The mounting hole is configured to receive a mounting pin disposed on the implement. The coupler further includes a locking mechanism. The locking mechanism includes an actuation system rigidly coupled to the mounting structure. The locking mechanism includes a catch plate operatively connected to the actuation system and configured to selectively lock the mounting pin received in the mounting hole.

In one aspect, the present disclosure provides an implement removably attachable to a coupler of a machine. The implement includes a material handling portion. The implement includes a coupler attachment portion extending from the material handling portion. The implement includes a mounting pin disposed on the coupler attachment portion and configured to be received in a mounting hole provided on the coupler and selectively locked by a locking mechanism.

In another aspect, the present disclosure provides an implement system for a machine. The implement system includes an implement. The implement includes a material handling portion. The implement includes a coupler attachment portion extending from the material handling portion. The implement further includes a mounting pin disposed on the coupler attachment portion. The implement system further includes a coupler removably attachable to the implement. The coupler includes a mounting structure. The mounting structure includes a frame and an attachment part rigidly attached to the frame. The attachment part is configured to attach the coupler with the machine. The mounting structure further includes a mounting hole disposed on the frame. The mounting pin is received in the mounting hole. The coupler further includes a locking mechanism. The locking mechanism includes an actuation system rigidly coupled to the mounting structure. The locking mechanism includes a catch plate operatively connected to the actuation system and configured to selectively lock the mounting pin received in the mounting hole.

Other features and aspects of this disclosure will be apparent from the following description and the accompanying drawings.

### BRIEF DESCRIPTION OF THE DRAWINGS

FIG. 1 illustrates a perspective view of an exemplary machine;

FIG. 2 illustrates a perspective view of an implement system associated with the machine of FIG. 1;

FIG. 3 illustrates a rear view of the coupler;

FIG. 4 illustrates a perspective view of a coupler indication assembly associated with coupler of FIG. 3;

FIGS. 5 and 6 illustrate perspective views of the implement system and the coupling indication assembly during a step of coupling of the implement to the coupler;

FIGS. 7 and 8 illustrate an indicator window during various positions of a flag member associated with the coupling indication assembly;

FIGS. 9 and 10 illustrate perspective views of the implement system and the coupling indication assembly during another step of coupling of the implement to the coupler;

FIGS. 11 and 12 illustrate perspective views of the implement system and the coupling indication assembly during another step of coupling of the implement to the coupler;

FIG. 13 illustrates an indicator window during various positions of a flag member associated with the coupling indication assembly; and

FIG. 14 illustrates a perspective view of the implement according to another embodiment of the present disclosure.

### DETAILED DESCRIPTION

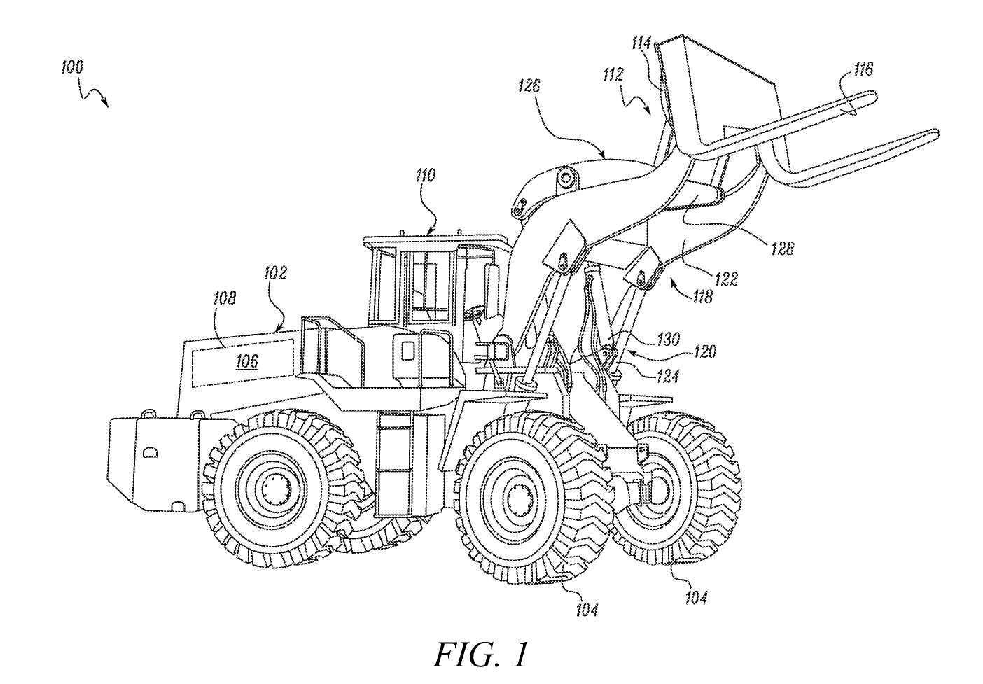

The present disclosure relates to an implement system for a machine and more particularly to a coupler and a locking mechanism to securely couple an implement with the coupler. References will now be made in detail to specific embodiments or features, examples of which are illustrated in the accompanying drawings. Wherever possible, the same reference numbers will be used throughout the drawings to refer to the same or like parts. FIG. 1 illustrates an exemplary machine 100. In an embodiment, the machine 100 is illustrated as a wheel loader. In various alternative embodiments, the machine 100 may be any machine such as, a backhoe loader, a track type tractor, a compactor, an excavator, a skid steer loader, or any other agricultural, mining or construction machinery.

As illustrated in FIG. 1, the machine 100 may include a chassis 102. A set of ground engaging members 104, such as wheels or tracks, may also be provided on the machine 100 for the purpose of mobility. A powertrain or a drivetrain (not shown) may be provided on the machine 100 for the production and transmission of a motive power. The powertrain may include a power source 106 that may be located within an enclosure 108 and supported on the chassis 102 of the machine 100. The power source 106 may embody an internal combustion engine such as, for example, a diesel engine, a gasoline engine, a gaseous fuel powered engine, or any other type of engine apparent to one skilled in the art. The power source 106 may alternatively or additionally include a non-combustion source of power such as a fuel cell, a power storage device, an electric motor, or other similar mechanism. The powertrain may further include a torque converter, transmission inclusive of gearing, drive shaft and other known drive links provided between the power source 106 and the set of ground engaging members 108 for the transmission of the motive power.

The machine 100 includes an operator cab 110 which houses controls and/or operator display devices (not shown) for operating and/or monitoring the machine 100. Operator display device may be one of a liquid crystal display (LCD), a cathode ray tube (CRT), a personal digital assistant (PDA), a plasma display, a touchscreen, a monitor, a portable hand-held device, or any other display known in the art.

As shown in FIG. 1, the machine 100 includes an implement system 112. The implement system 112 includes a coupler 114 and an implement 116 removably attached to the coupler 114. The implement system 112 may be moved upwards and downwards and/or tilted in order to perform various operations. In the illustrated embodiment, the implement 116 is embodied as a fork to lift, carry, and dump a variety of materials. However, in other embodiments the implement 116 may include, but not limited to, a bucket, a shovel, or a blade to perform various operations.

The machine 100 may have a linkage assembly 118 attached to the chassis 102. The implement system 112 may be connected to the chassis 102 of the machine 100 by the linkage assembly 118 that may be configured to move the implement system 112. The kinematic arrangement of various elements in the linkage assembly 118 may control a lift and a tilt movement of the coupler 114 and thus controls the movement of the implement 116 attached thereto. In an embodiment, the linkage assembly 118 includes a lifting arrangement 120 for controlling the upward and downward movement of the implement 116. The lifting arrangement 120 includes a lift arm 122 coupled to the chassis 102 by means of one or more pivot connections. One or more lift cylinders 124 may be operatively coupled to the lift arms 122 and provide an actuation force for an upward and downward movement of the implement system 112. As illustrated, two lift arms 122 may be provided, with each having corresponding lift cylinders 124. However, a single lift arm 122 driven by a single lift cylinder 124, two lift arms 122 driven by the single lift cylinder 124, or other arrangements of the lift arms 122 and the lift cylinders 124 may be contemplated within the scope of the present disclosure. The lift cylinder 124 may be extended to raise the lift arm 122 and retracted to lower the lift arm 122 and hence effect the lift movement of the implement 116.

The tilt movement of the implement 116 is controlled by a tilting arrangement 126, in the linkage assembly 118. The tilting arrangement 126 may include one or more tilt arms 128. One or more tilt cylinders 130 may be coupled to the tilt arm 128 to provide an actuation force for the tilt movement of the implement 116. The lift cylinder 124 and the tilt cylinder 130 are hydraulic cylinders driven by a pump using a pressurized hydraulic fluid, or alternatively may be some other kind of actuators such as a pneumatic linear actuators, electro-mechanical actuators, or the like. Further, it may be noted that the linkage assembly 118 and the implement 116 of the machine 100 may vary based on the type of machine 100 or the type of operation or task required to be carried out by the machine 100.

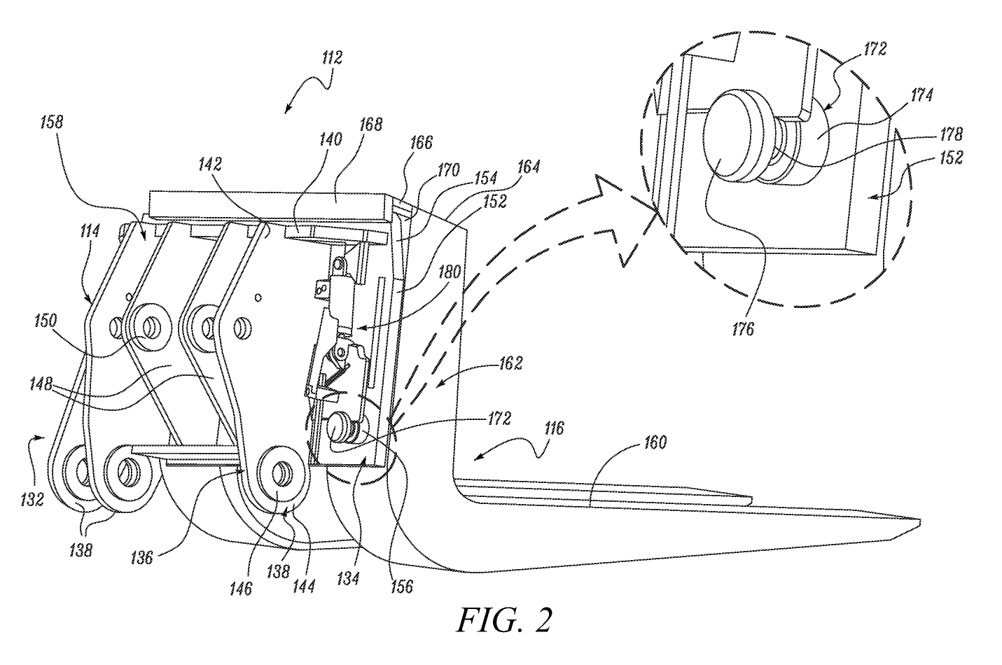

FIG. 2 illustrates a perspective view of the implement system 112 of FIG. 1. According to an embodiment, the coupler 114 includes a mounting structure 132. The mounting structure 132 includes a frame 134 and an attachment part 136 rigidly attached to the frame 134. The attachment part 136 attaches the coupler 114 to the linkage assembly 118 of the machine 100. The attachment part 136 may include pairs of spaced apart plates, such as primary plates 138 rigidly attached to the frame 134. The primary plates 138 are supported by a plate member 140 extending transversely from the frame 134. The primary plates 138 include a top end 142 and a bottom end 144. The top end 142 of the primary plates 138 is rigidly attached to the plate member 140. The bottom end 144 defines a set of aligned primary openings 146 to attach the lift arm 122 of the linkage assembly 118 with the coupler 114. In an embodiment, the attachment part 136 may further include another pair of spaced apart secondary plates 148 having a set of aligned secondary openings 150 to attach with the tilt arm 128 of the linkage assembly 118. In an embodiment, the set of aligned primary and secondary openings 146, 150 may be a set of bossed openings as commonly known in the art. In the illustrated embodiment, the coupler 114 includes two pairs of primary plates 138 disposed on either side of the frame 134 and configured to attach to the pair of lift arms 122 of the linkage assembly 118. The pair of secondary plates 148 is disposed substantially between the pair of primary plates 138 and is configured to attach the tilt arm 128 of the linkage assembly 118 with the machine 100.

It will be apparent to a person having ordinary skill in the art, positioning of the primary and the secondary openings 146, 150, and their method of attachment to the lift arms 122 and the tilt arms 128 as discussed herein are merely exemplary in nature and thus non-limiting to this disclosure. One may contemplate other suitable positions for the primary and the secondary openings 146, 150, and other suitable means for attaching them to the lift and the tilt arms 122, 128 to allow movement of the coupler 114 and the implement 116 attached thereto.

The frame 134 includes a mounting portion 152 and a support portion 154 extending from the mounting portion 152. The mounting structure 132 further includes one or more mounting holes 156 disposed on the mounting portion 152 of the frame 134. The mounting holes 156 may be substantially circular, substantially rectangular, or of any other shape. In the illustrated embodiment, the mounting structure 132 includes a pair of substantially circular mounting holes 156 disposed on either side of the frame 134. In an embodiment, the mounting holes 156 may be disposed in a cavity 158 defined by the plate member 140 and the primary plates 138.

The implement 116 includes a material handling portion 160 and a coupler attachment portion 162 extending from the material handling portion 160. In an embodiment, the material handling portion 160 may include a pair of forks. The coupler attachment portion 162 defines a top surface 164. A flange 166 extends transversely from the top surface 164 of the coupler attachment portion 162. The implement 116 further includes a collar 168 extending transversely from the flange 166 such that the collar 168 and the coupler attachment portion 162 define a receptacle 170 therebetween. As shown in FIG. 2, the support portion 154 associated with the frame 134 of the coupler 114 is wedgably engaged within the receptacle 170 provided on the implement 116.

In an embodiment, the implement 116 includes a mounting pin 172 disposed on the coupler attachment portion 162. The mounting pin 172 includes a proximal end 174 and a distal end 176. The mounting pin 172 is attached to the coupler attachment portion 162 at the proximal end 174. As illustrated in a detailed view of FIG. 2, a recessed portion 178 extends between the proximal end 174 and the distal end 176 of the mounting pin 172. The mounting pin 172 is received in the mounting hole 156 of the coupler 114.

The coupler 114 further includes a locking mechanism 180. The locking mechanism 180 includes an actuation system 182 rigidly coupled to the mounting structure 132. The locking mechanism 180 further includes a catch plate 184 operatively connected to the actuation system 182 and configured to selectively lock the mounting pin 172 received in the mounting hole 156. In the illustrated embodiment, the locking mechanism 180 is disposed in the cavity 158 defined by the plate member 140 and the primary plates 138 such that a locking surface 186 of the catch plate 184 may be selectively movable over the mounting hole 156. The actuation system 182 includes a cylinder 188 and a piston 190 reciprocably mounted within the cylinder 188. The cylinder 188 may be rigidly attached to one of the primary plates 138. Further, the cylinder 188 may be a hydraulically or a pneumatically actuated cylinder as commonly known in the art. The catch plate 184 is coupled to the piston 190 such that the locking surface 186 of the catch plate 184 may be engaged with the recessed portion 178 of the mounting pin 172.

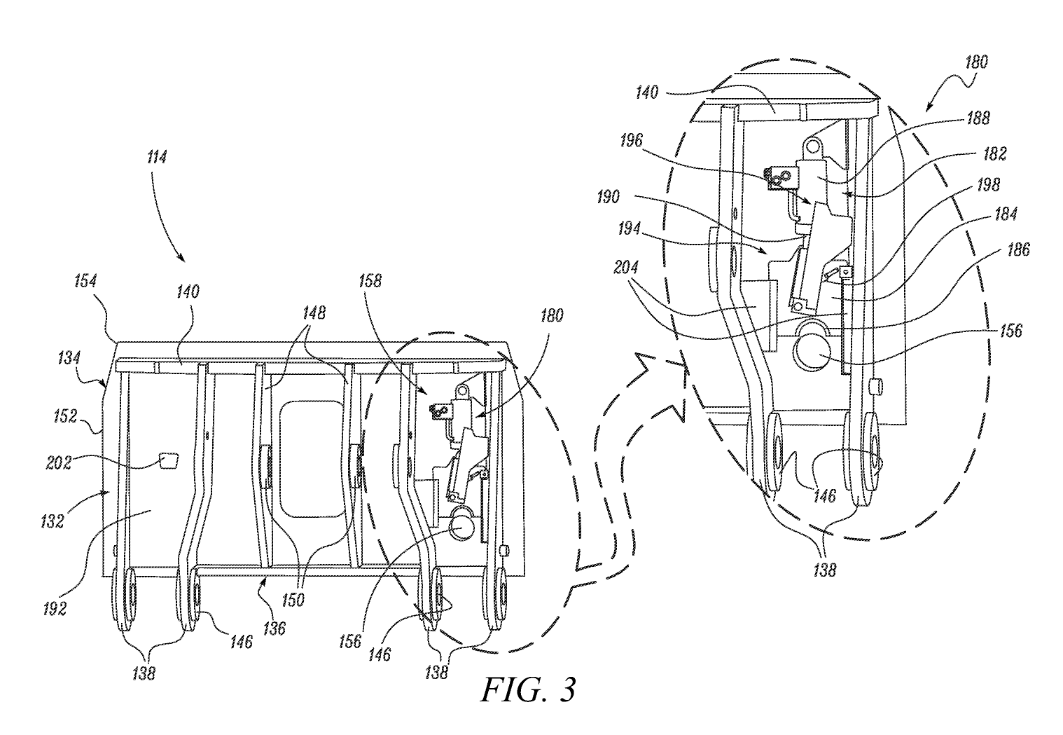

FIG. 3 illustrates a rear view of the coupler 114. In an embodiment, the coupler 114 further includes a face plate 192 disposed over the cavity 158 and attached to the primary plates 138. The face plate 192 covers the locking mechanism 180. In the illustrated embodiment, the coupler 114 includes two face plates 192, each disposed over the cavities 158 defined by the two pairs of primary plates 138. However, one of the face plates 192 is removed to illustrate the locking mechanism 180 disposed in one of the cavity 158. In an embodiment, the coupler 114 includes a coupling indication assembly 194 operatively coupled to the locking mechanism 180 of the coupler 114. The coupling indication assembly 194 includes a flag member 196 pivotally coupled to the catch plate 184 of the locking mechanism 180. A resilient member 198 is attached to the flag member 196 to bias the flag member 196 to a first position (as shown in FIG. 3). The coupling indication assembly 194 further includes a probe member 200 attached to the flag member 196. The probe member 200 is configured to interact with the mounting pin 172 of the implement 116 received in the mounting hole 156 to move the flag member 196 to a second position (not shown in FIG. 3). The second position indicates that the implement 116 is positively locked with the coupler 114. In an embodiment, the coupling indication assembly 194 further includes an indicator window 202 disposed on the face plate 192. The indicator window 202 is positioned such that a position of the flag member 196 may be visible via the indicator window 202. When the flag member 196 is in the second position, the flag member 196 covers the indicator window 202 completely. Alternatively, when the flag member 196 is in the first position, the flag member 196 is not visible via the indicator window 202.

The attachment part 136 of the coupler 114 further includes a pair of guide plates 204 disposed in the cavity 158 and rigidly attached to the primary plates 138. The pair of guide plates 204 defines a guided path for the movement of the catch plate 184 towards the mounting hole 156 and allows locking of the catch plate 184 in the recessed portion 178 of the mounting pin 172.

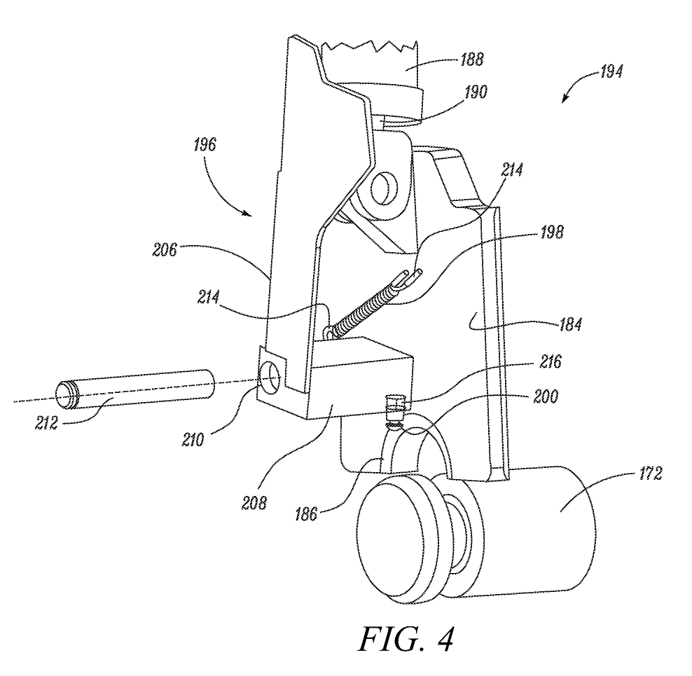

FIG. 4 illustrates a perspective view of the coupling indication assembly 194. The flag member 196 includes a flag 206 rigidly attached to a base member 208. The base member 208 includes a through-hole 210 that may receive a pivot pin 212 to pivotally couple the base member 208 to the catch plate 184. The resilient member 198 is attached to the base member 208 and the catch plate 184 via respective U shaped pins 214 disposed on the base member 208 and the catch plate 184. The resilient member 198 is configured to bias the flag member 196 towards the first position. In an embodiment, the resilient member 198 is a spring. The probe member 200 is attached to the base member 208 of the flag member 196. The base member 208 includes a receptacle 216 disposed at an opposite end from the through-hole 210. The receptacle 216 may releasably couple the probe member 200 to the base member 208. The through-hole 210 and the receptacle 216 are positioned on either ends of the base member 208 to allow a pivotal motion of the base member 208 along the pivot pin 212 when the probe member 200 interacts with the distal end 176 of the mounting pin 172. In an embodiment, the probe member 200 includes a carriage bolt and a jam nut. Thus, the carriage bolt may be received in the receptacle 216 and the jam nut may fasten the probe member 200 to the base member 208.

### INDUSTRIAL APPLICABILITY

The industrial applicability of the implement system 112 for the machine 100 described herein will be readily appreciated from the foregoing discussion.

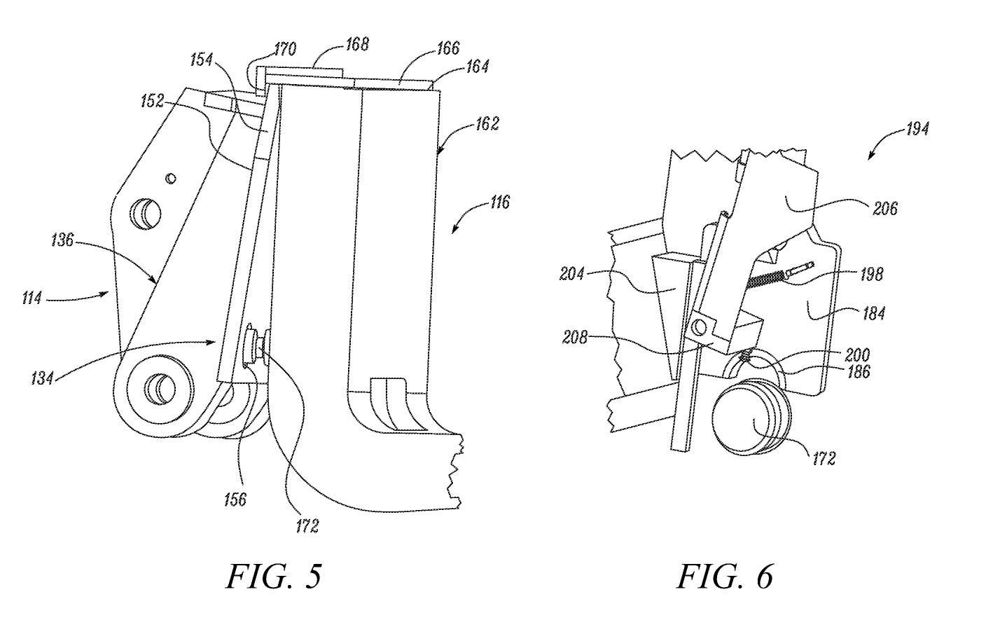

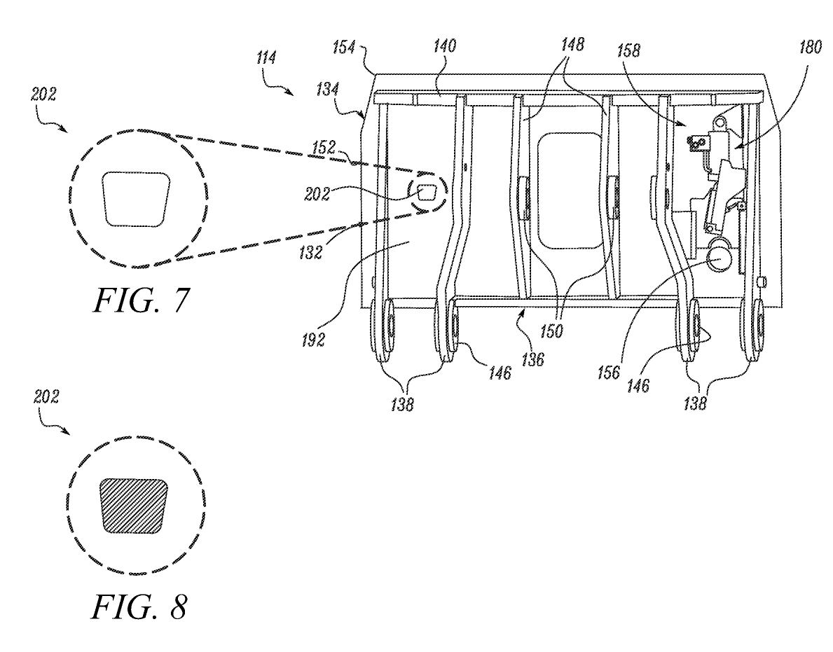

A method of coupling the implement 116 to the coupler 114 of the machine 100 is provided. FIGS. 5, 7 and 9 illustrate perspective views of the implement system 112 during coupling of the implement 116 to the coupler 114 and FIGS. 6, 8 and 10 illustrate perspective views of the coupling indication assembly 194 during coupling of the implement 116 to the coupler 114. The method includes wedgably engaging the frame 134 of the coupler 114 within the receptacle 170 provided on the implement 116. As shown in FIG. 5, the support portion 154 associated with the frame 134 of the coupler 114 is wedgably engaged within the receptacle 170 provided on the implement 116. The mounting pin 172 abuts the mounting hole 156 and the piston 190 is retracted in the cylinder 188. As shown in FIG. 6, the flag member 196 is biased in the first position by the resilient member 198. Thus the indicator window 202 is not covered with the flag 206 and indicates that the implement 116 is not positively locked with the coupler 114 (shown in FIG. 7).

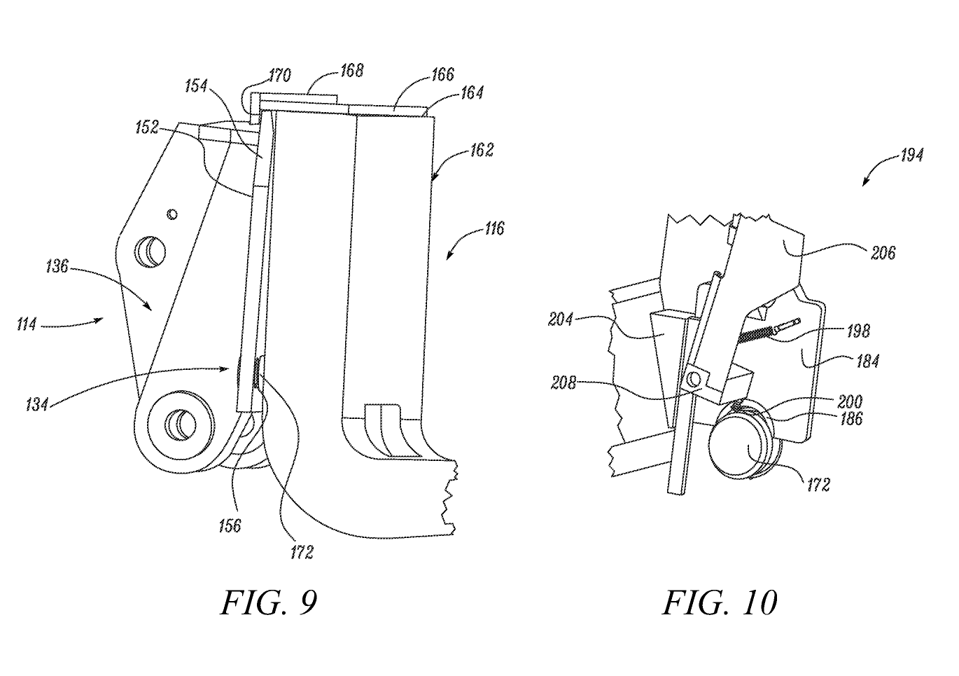

FIGS. 7 and 8 illustrate the indicator window 202 during various positions of the flag member 196 associated with the coupling indication assembly 194 of FIG. 4. FIG. 7 illustrates the indicator window 202 when the flag 206 is in the first position. FIG. 8 illustrates the indicator window 202 when the flag 206 is in the second position. As shown in FIG. 9, the method further includes receiving the mounting pin 172 disposed on the implement 116 in the mounting hole 156 provided on the frame 134 of the coupler 114. As shown in FIG. 10, the flag member 196 is still biased in the first position by the resilient member 198 such that the indicator window 202 is not covered with the flag 206 and indicates that the implement 116 is not positively locked with the coupler 114 (shown in FIG. 7). The operator may then actuate the locking mechanism 180 to move the catch plate 184 towards the mounting hole 156.

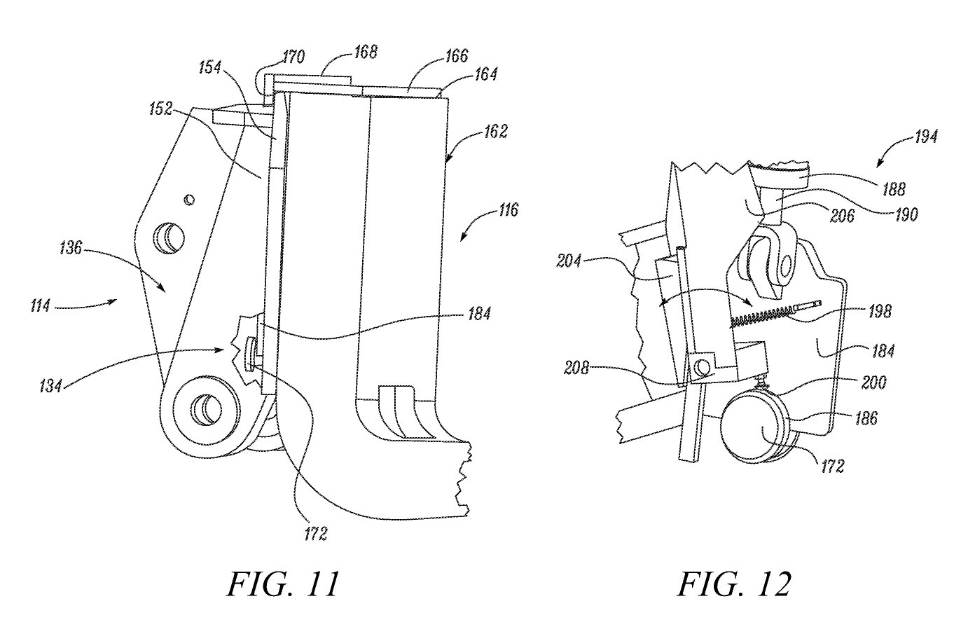

As shown in FIG. 11 the method includes moving the catch plate 184 towards the mounting pin 172 to lock the mounting pin 172 in the mounting hole 156. The recessed portion 178 of the mounting pin 172 is engaged with the locking surface 186 of the catch plate 184. The distal end 176 of the mounting pin 172 allows locking of the mounting pin 172 by the catch plate 184. The method further includes interacting the probe member 200 with the mounting pin 172 to move the flag member 196 in the second position (shown by an arrow). As shown in FIGS. 11 and 12, when the locking surface 186 of the catch plate 184 engages the recessed portion 178 of the mounting pin 172, the probe member 200 interacts with the distal end 176 of the mounting pin 172 such that the base members 208 pivots about the pivot pin 212 to bias the flag 206 towards the second position. The method further includes providing an indication of that the implement 116 is positively locked with the coupler 114. The indicator window 202 is covered by the flag 206 and indicates that the implement 116 is positively locked with the coupler 114 (shown in FIG. 8).

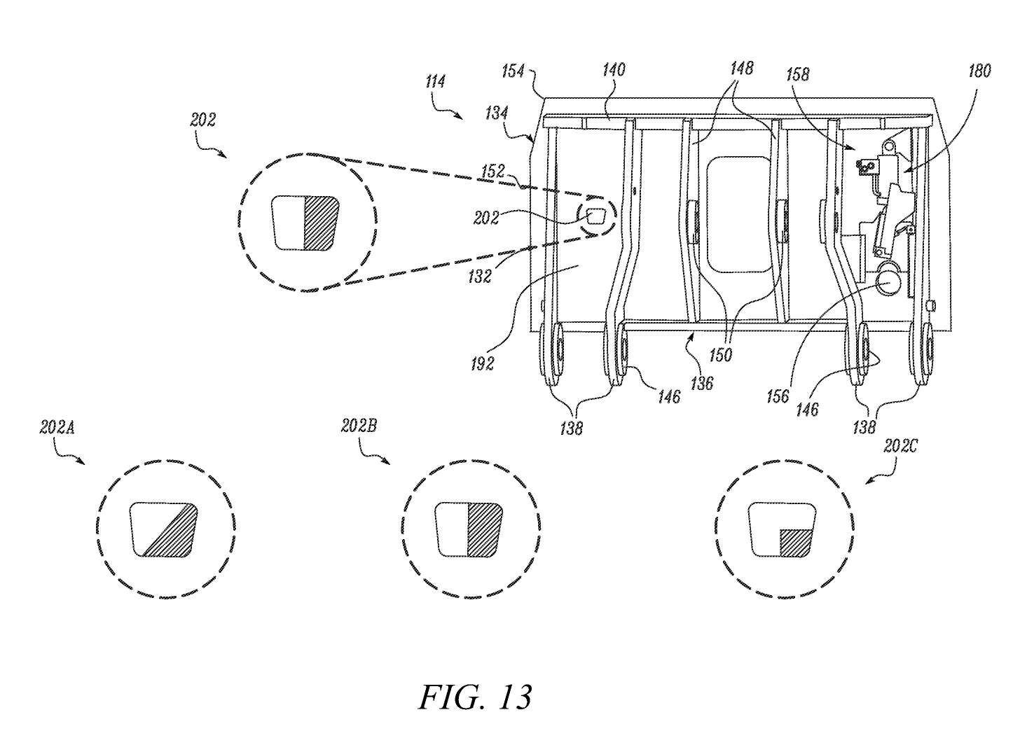

During engagement of the locking surface 186 with the recessed portion 178 of the mounting pin 172, if the locking surface 186 is partially received in the recessed portion 178 due to misalignment, or wear of parts, the probe member 200 may partially interact with the mounting pin 172 and the indicator window 202 may be partially covered with the flag 206. FIG. 13 illustrates the indicator window 202 when the implement 116 is not positively locked with the coupler 114. The partial coverage of the indicator window 202 may indicate that the implement 116 is not positively locked with the coupler 114 due to misalignment or wear of the mounting pin 172 and/or mounting hole 156, or a fault in the actuation system 182 and/or the coupling indication system 194. As shown in FIG. 13, the partial coverage of the indicator window may include one of the following configurations—202A, 202B, and 202C. Configuration 202A may be indicative of a wear in one or more components associated with the implement 116 and/or the coupler 114. Thus, a repair and/or a service of the associated components may be performed. Configuration 202B may indicate that a complete engagement of the implement 116 with the coupler 114 is being obstructed. Accordingly, the operator may inspect the coupler 114 and the implement 116 for any debris or obstruction that may inhibit a positive coupling of the implement 116 to the coupler 114. Configuration 202C may indicate a fault in the actuation system 182.

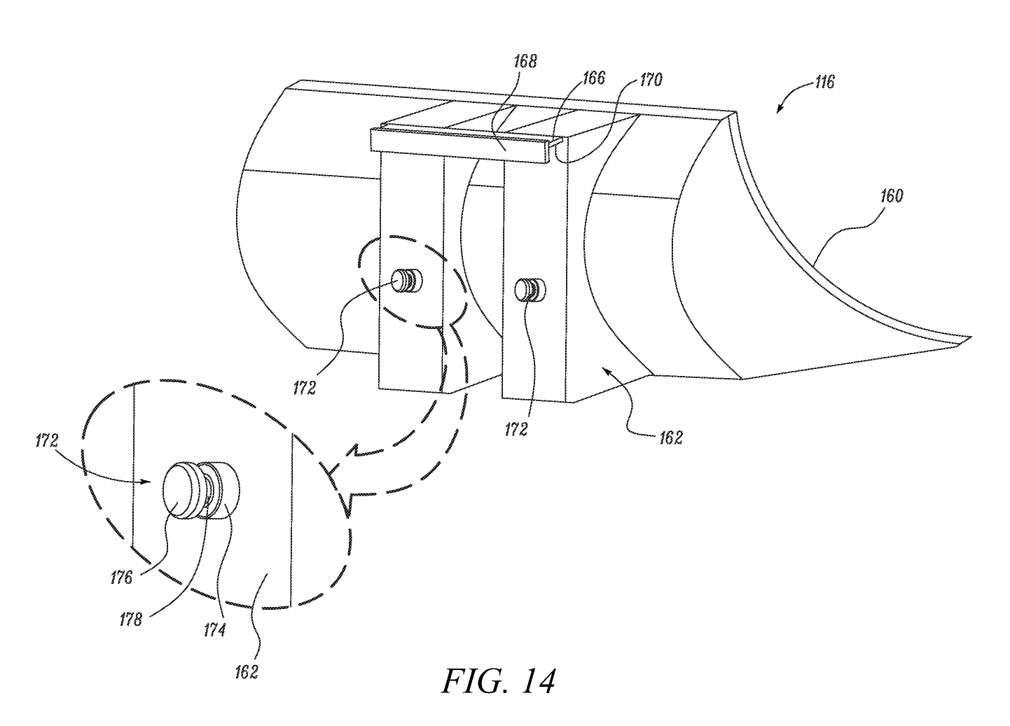

FIG. 14 illustrates a perspective view of the implement 116 according to another embodiment of the present disclosure. The implement 116 is illustrated as a bucket. The bucket includes the material handling portion 160 and the coupler attachment portion 162 as explained with conjunction to the fork in the preceding embodiments of the present disclosure. The coupler attachment portion 162 may include or more mounting pins 172 disposed thereon. Thus one may contemplate other implements like a shovel, or a blade that may include similar arrangements of the mounting pin 172 and the receptacle 170 as illustrated for the fork and the bucket in the present disclosure. During operation of the machine 100, the implement 116 may be required to perform various operations that require a combination of the up, down and tilting movement of the implement 116. The collar 168 provided on the implement 116 provides a support to the support portion 154 during various operations performed by the implement 116. It will be apparent to a person having an ordinary skill in the art that the implement system 112 of the present disclosure includes fewer parts and thus, is easy to manufacture and assemble. Furthermore, with the coupling indication assembly 194, the operator may identify if the implement 116 is positively locked with the coupler 114 without a manual inspection of the coupling status of the implement 116 and the coupler 114 and thus save time to increase a productivity of the machine 100.

From the foregoing it will be appreciated that, although specific embodiments have been described herein for purposes of illustration, various modifications or variations may be made without deviating from the spirit or scope of inventive features claimed herein. Other embodiments will be apparent to those skilled in the art from consideration of the specification and figures and practice of the arrangements disclosed herein. It is intended that the specification and disclosed examples be considered as exemplary only, with a true inventive scope and spirit being indicated by the following claims and their equivalents.

What is claimed is:

1. A coupler for attaching an implement to a machine, the coupler comprising:
a mounting structure comprising:
a frame;
an attachment part rigidly attached to the frame, the attachment part configured to attach the coupler with the machine; and
a mounting hole disposed on the frame, the mounting hole configured to receive a mounting pin disposed on the implement; and
a locking mechanism comprising:
an actuation system rigidly coupled to the mounting structure; and
a catch plate operatively connected to the actuation system and configured to selectively lock the mounting pin received in the mounting hole.

2. The coupler of claim 1, wherein the attachment part includes at least one pair of spaced apart plates rigidly attached to the frame.

3. The coupler of claim 1, wherein the pair of spaced apart plates define a cavity and the mounting hole is disposed therebetween.

4. The coupler of claim 3, wherein the locking mechanism is disposed in the cavity such that a locking surface of the catch plate is selectively movable over the mounting hole.

5. The coupler of claim 3, wherein the actuation system of the locking mechanism includes a cylinder and a piston reciprocably mounted within the cylinder, and wherein the cylinder is rigidly attached to one of the spaced apart plates and the catch plate is coupled to the piston.

6. The coupler of claim 2, wherein the pair of spaced apart plates having aligned openings configured to attach a lift arm of the machine with the coupler.

7. The coupler of claim 3 further including a pair of guide plates disposed in the cavity and rigidly attached to the pair of spaced apart plates, wherein the guide plates define a guided path for the movement of the catch plate towards the mounting hole.

8. The coupler of claim 3 further including a face plate disposed over the cavity and attached to the spaced apart plates, wherein the face plate covers the locking mechanism.

9. The coupler of claim 1, wherein the frame including:
a mounting portion; and
a support portion extending from the mounting portion, wherein the support portion is configured to be wedgably engaged within a receptacle provided on the implement.

10. An implement removably attachable to a coupler of a machine, the implement comprising:
a material handling portion;
a coupler attachment portion extending from the material handling portion; and
a mounting pin disposed on the coupler attachment portion and configured to be received in a mounting hole provided on the coupler and selectively locked by a locking mechanism.

11. The implement of claim 10, wherein the mounting pin includes:
a proximal end;
a distal end; and
a recessed portion extending between the proximal end and the distal end, wherein the recessed portion is configured to be engaged with the locking mechanism of the coupler.

12. The implement of claim 10 further comprising:
a flange extending transversely from the coupler attachment portion; and
a collar extending transversely from the flange such that the collar and the coupler attachment portion define a receptacle therebetween, the receptacle configured to wedgably engage a frame of the coupler.

13. The implement of claim 10, wherein the implement is at least one of a bucket, and a fork.

14. An implement system for a machine, the implement system comprising:
an implement comprising:
a material handling portion;
a coupler attachment portion extending from the material handling portion; and
a mounting pin disposed on the coupler attachment portion; and
a coupler removably attachable to the implement, the coupler comprising:
a mounting structure comprising:
a frame;
an attachment part rigidly attached to the frame, the attachment part configured to attach the coupler with the machine; and
a mounting hole disposed on the frame, the mounting pin is received in the mounting hole; and
a locking mechanism comprising:
an actuation system rigidly coupled to the mounting structure; and
a catch plate operatively connected to the actuation system and configured to selectively lock the mounting pin received in the mounting hole.

15. The implement system of claim 14, wherein the mounting pin includes:
a proximal;
a distal end; and
a recessed portion extending between the proximal end and the distal end, wherein the recessed portion is engaged with the locking mechanism of the coupler.

16. The implement system of claim 14, wherein the frame including:
a mounting portion; and
a support portion extending from the mounting portion, wherein the support portion is configured to be wedgably engaged within a receptacle provided on the implement.

17. The implement system of claim 16, wherein the implement further comprising:
a flange transversely extending from the coupler attachment portion; and
a collar transversely extending from the flange such that the collar and the coupler attachment portion define a receptacle therebetween, wherein the second plate is wedgably engaged within the receptacle.

18. The implement system of claim 14, wherein the attachment part includes at least one pair of spaced apart plates defining a cavity and the mounting hole is disposed therebetween.

19. The implement system of claim 18, wherein the locking mechanism is disposed in the cavity such that a locking surface of the catch plate is selectively movable over the mounting hole.

20. The implement system of claim 18, wherein the actuation system of the locking mechanism includes a cylinder and a piston reciprocably mounted within the cylinder, and wherein the cylinder is rigidly attached to one of the spaced apart plates and the catch plate is coupled to the piston.

21. The implement system of claim 18, wherein the pair of spaced apart plates having aligned openings configure to attach a lift arm of the machine with the coupler.
